(19) United States
(12) Patent Application Publication
(10) Pub. No.: US 2026/0025097 A1
(43) Pub. Date: Jan. 22, 2026

(54) MULTI-PIVOT JOINT SUPPORT STRUCTURES FOR SOLAR TRACKERS

(71) Applicant: Nextracker LLC, Fremont, CA (US)

(72) Inventors: Alexander W. AU, Oakland, CA (US); Harry VAN, Oakland, CA (US); Ryan Patel, Pleasanton, CA (US)

(21) Appl. No.: 19/256,959

(22) Filed: Jul. 1, 2025

Related U.S. Application Data
(60) Provisional application No. 63/672,330, filed on Jul. 17, 2024.

(51) Int. Cl. H02S 20/32

(52) U.S. Cl. CPC H02S 20/32

(57) ABSTRACT

A solar tracker support structure includes a first leg, a second leg, a bridge, a first pair of pivot joints, and a second pair of pivot joints. The first leg includes first leg proximal and distal end portions. The second leg includes second leg proximal and distal end portions. The bridge extends between the first leg proximal and second leg proximal end portion. The first pair of pivot joints is configured to move the solar tracker support structure about a first axis. The second pair of pivot joints is configured to move the solar tracker support structure about a second, different axis.

### RELATED APPLICATIONS

This application claims the benefit of U.S. Provisional Patent Application No. 63/672,330, filed Jul. 17, 2024, the entire contents of which are incorporated herein by reference.

### TECHNICAL FIELD

This disclosure generally relates to support structures for solar trackers. Embodiments disclosed herein include a support structure for a solar tracker having multiple pairs of pivot joints at the support structure to accommodate support structure pivoting in multiple, different directions about multiple, different axes.

### BACKGROUND

To follow the trajectory of the sun, solar trackers mount solar modules on a torque tube which is rotatably supported on a plurality of piers. Both during installation and operation of the solar tracker, deviations in alignment can occur. For example, the torque tube of the solar tracker may deviate along its longitudinal axis as it extends between support structures along the length of the torque tube. During installation, this can result, for instance, from, ground elevation changes along the length of the torque tube. During operation, this can result, for instance, from thermal fluctuations imparted to components of the solar tracker resulting in expansion or contraction of such component(s), such as the torque tube.

The torque tubes of the solar tracker are rotatably supported on the piers by a coupling. These couplings enable the torque tube to rotate about its longitudinal axis and in many embodiments, enable the torque tube to axially slide within the coupling to accommodate thermal expansion and contraction of the torque tube and/or to accommodate slight installation tolerances/deviations in the field. Axial movement or other positional deviations of the torque tube can impart significant loads on the couplings and the piers supporting them and/or can impede rotational positioning of solar modules coupled to the torque tube. This is turn can limit the useful life of a solar tracker by imparting stresses on the components and/or impede functional operation of the solar tracker by limiting the range of rotational positions at which the solar modules can be moved via the torque tube, which can limit the operational efficiency of the solar tracker to generate power from the incident solar energy.

### SUMMARY

In general, this disclosure describes a support structure for a solar tracker that includes multiple pivot joints at the support structure to accommodate support structure pivoting in multiple, different directions. This in turn can configure the support structure to pivot, in two or more difference directions, in a manner that avoids limiting certain rotational positions of the solar modules coupled to the tracker torque tube and/or accommodates stresses imparted on the support tracker via torque tube positional deviation during operational life of the solar tracker. For example, support structure embodiments disclosed herein can accommodate north—south expansion of a torque tube by pivoting in a north—south direction (e.g., pivot about an east-west axis in a north or south direction) about one pivot joint at the support structure and accommodate yaw at the support structure by pivoting about a vertical axis to the ground about another, different pivot joint at the support structure. In this way, such a support structure can both accommodate (i) installation and/or operational deviation of torque tube position via one pivot joint at the support structure and (ii) increased solar module rotational positioning via the another pivot joint at the support structure such that the support structure can yaw or twist about the vertical axis to the ground to avoid interfering with/impeding further rotation of the solar modules.

One embodiment includes a solar tracker support structure. This embodiment of the solar tracker support structure includes a first leg, a second leg, a bridge, a first pair of pivot joints, and a second pair of pivot joints. The first leg includes a first leg proximal end portion and a first leg distal end portion. The second leg includes a second leg proximal end portion and a second leg distal end portion. The bridge extends between the first leg proximal end portion and the second leg proximal end portion. The first pair of pivot joints includes a first pair first pivot joint at the first leg and a first pair second pivot joint at the second leg. The first pair of pivot joints is configured to move the solar tracker support structure about a first axis. The second pair of pivot joints includes a second pair first pivot joint at the first leg and a second pair second pivot joint at the second leg. The second pair first pivot joint is spaced apart from the first pair first pivot joint along the first leg, and the second pair second pivot joint is spaced apart from the first pair second pivot joint along the second leg. The second pair of pivot joints is configured to move the solar tracker support structure about a second axis.

In a further embodiment of this solar tracker support structure, the first axis is an east—west axis, and the second axis is a vertical axis to ground. The second pair of pivot joints can be configured to impart yaw at the solar tracker support structure to cause the solar tracker support structure to twist about the vertical axis to ground. For example, as the first pair first pivot joint and the first pair second pivot joint pivot about the east-west axis in a north or south direction, the second pair first pivot joint and the second pair second pivot joint can be caused to rotate about the vertical axis to ground to twist the solar tracker support structure about the vertical axis to ground. The first leg distal end portion can be configured to couple to a first subterranean pile, and the second leg distal end portion can be configured to couple to a second subterranean pile. The first pair first pivot joint can be closer to the first leg distal end portion than the second pair first pivot joint, and the first pair second pivot joint can be closer to the second distal end portion than the second pair second pivot joint. The first pair first pivot joint can be aligned with the first pair second pivot joint about a first pair axis that extends horizontally to ground at a first elevation along the solar tracker support structure. The second pair first pivot joint can be aligned with the second pair second pivot joint about a second pair axis that extends horizontally to ground at a second elevation along the solar tracker support structure, where the second elevation is higher above ground than the first elevation.

For certain such embodiments, the first pair first pivot joint at the first leg and the first pair second pivot joint at the second leg can each include a pin joint, and the second pair first pivot joint at the first leg and the second pair second pivot joint at the second leg can each include a ball joint. For example, the pin joint at the first pair first pivot joint can include a first pin that extends through the first leg and a first subterranean pile along the first axis, and the pin joint at the first pair second pivot joint can include a second pin that extends through the second leg and a second subterranean pile along the first axis.

For certain such other embodiments, the first pair first pivot joint at the first leg and the first pair second pivot joint at the second leg can each include a ball joint, and the second pair first pivot joint at the first leg and the second pair second pivot joint at the second leg can each include a ball joint. For example, the ball joint of each of the first pair first pivot joint at the first leg and the first pair second pivot joint at the second leg can each include a hydroformed ball joint, and the ball joint of each of the second pair first pivot joint at the first leg and the second pair second pivot joint at the second leg can each include a hydroformed ball joint.

For some embodiments, the second pair of pivot joints can be configured to impart yaw at the solar tracker support structure to cause the solar tracker support structure to twist about the vertical axis to ground to accommodate a solar module stow position up to positive seventy five degrees in one rotational direction and up to minus seventy five degrees in another, opposite rotational direction.

For some embodiments, the first leg can include a first leg distal vertical segment at the first leg distal end portion, a first leg convergence segment between the first leg distal end portion and the first leg proximal end portion, and a first leg proximal vertical segment at the first leg proximal portion. And the second leg can include a second leg distal vertical segment at the second leg distal end portion, a second leg convergence segment between the second leg distal end portion and the second leg proximal end portion, and a second leg proximal vertical segment at the second leg proximal portion. In some such examples, each of the first pair first pivot joint and the second pair first pivot joint can be at the first leg distal vertical segment, and each of the first pair second pivot joint and the second pair second pivot joint can be at the second leg distal vertical segment. The bridge can be configured to couple to a torque tube of a solar tracker system. In one further such example, the solar tracker support structure can further include a cross-brace extending between the first leg and the second leg. For instance, the cross-brace can be at the first leg convergence segment and closer to the first leg proximal end portion than each of the first pair first pivot joint and the second pair first pivot joint at the first leg, and the cross-brace can be at the second leg convergence segment and closer to the second leg proximal end portion than each of the first pair second pivot joint and the second pair second pivot joint at the second leg.

Another embodiment includes a solar tracker support structure. This embodiment of a solar tracker support structure includes a first leg, a second leg, a bridge, a first pair of pivot joints, and a second pair of pivot joints. The first leg includes a first leg proximal end portion and a first leg distal end portion. The second leg includes a second leg proximal end portion and a second leg distal end portion. The bridge extends between the first leg proximal end portion and the second leg proximal end portion. The first pair of pivot joints includes a first pair first pivot joint at the first leg and a first pair second pivot joint at the second leg. The first pair of pivot joints is configured to move the solar tracker support structure about a first axis. The second pair of pivot joints includes a second pair first pivot joint at the first leg and a second pair second pivot joint at the second leg. The second pair first pivot joint is spaced apart from the first pair first pivot joint along the first leg, and the second pair second pivot joint is spaced apart from the first pair second pivot joint along the second leg. The second pair of pivot joints is configured to move the solar tracker support structure about a second axis, and the second pair of pivot joints is configured to impart yaw at the solar tracker support structure to cause the solar tracker support structure to twist about the second axis.

In a further embodiment of this solar tracker support structure, the first can be an cast-west, and the second axis is a vertical axis to ground. For some such embodiments, as the first pair first pivot joint and the first pair second pivot joint pivot in a north and/or south direction about the cast-west axis, the second pair first pivot joint and the second pair second pivot joint are caused to rotate about the vertical axis to ground to twist the solar tracker support structure about the vertical axis to ground. For instance, the first pair first pivot joint is aligned with the first pair second pivot joint about a first pair axis that extends horizontally to ground at a first elevation along the solar tracker support structure, and the second pair first pivot joint is aligned with the second pair second pivot joint about a second pair axis that extends horizontally to ground at a second elevation along the solar tracker support structure, where the second elevation is higher above ground than the first elevation.

The details of one or more examples are set forth in the accompanying drawings and the description below. Other features, objects, and advantages will be apparent from the description and drawings, and from the enumerated embodiments.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a side view of an embodiment of a solar tracker system.

FIGS. 2A-2D illustrate one embodiment of a solar tracker support structure. FIG. 2A is a first side view of the solar tracker support structure, FIG. 2B is a second side view of the solar tracker support structure approximately ninety degrees offset from the first side view at FIG. 2A, FIG. 2C is an exploded view of one embodiment of pin joint as a type of pivot joint at the solar tracker support structure of FIGS. 2A and 2B, and FIG. 2D is an elevational view of one embodiment of a ball joint as a type of pivot joint at the solar tracker support structure of FIGS. 2A and 2B.

FIGS. 3A-3B illustrate another embodiment of a solar tracker support structure. FIG. 3A is a first side view of the solar tracker support structure, and FIG. 3B is a second side view of the solar tracker support structure approximately ninety degrees offset from the first side view at FIG. 3A.

FIGS. 4A-4B illustrate an embodiment of a solar tracker support structure having a first pair of pivot joints configured to move the solar tracker support structure about a first axis and a second pair of pivot joints configured to move the solar tracker support structure about a second, different axis. FIG. 4A is a side view showing movement of the support structure about the first axis via the first pair of pivot joints and about the second axis via the second pair of pivot joints, and FIG. 4B is a side view showing how such movement of the support structure about the first and second axes can accommodate increased angular solar module stow position.

FIG. 5 is a schematic diagram showing various locations along the solar module support structure for a pair of pivot joints.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

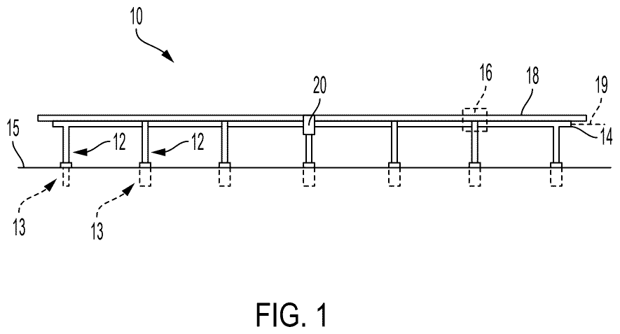

FIG. 1 is a side view of a solar tracker system 10 according to an embodiment of the present disclosure. The solar tracker system 10 can include a plurality of solar tracker support structures 12 disposed in spaced relation to one another. The embodiment shown here illustrates a plurality of subterranean piles 13 that are at least partially embedded in the earth below ground surface 15. Each subterranean pile 13 can be driven into the earth below the ground surface 15, and then each solar tracker support structure 12 can be coupled to one or more such subterranean piles 13 to support each solar tracker support structure 12 via the one or more subterranean piles 13. In some examples, a solar tracker support 12 can include multiple legs (e.g., two legs, three legs), and each leg of each solar tracker support 12 can be coupled to a dedicated subterranean pile 13. A torque tube 14 is supported at the solar tracker support structures 12, and the torque tube 14 can thus extend between two or more solar tracker support structures 12. In particular, the torque tube 14 can be rotatably supported at each of the solar tracker support structures 12 such that the torque tube 14 can rotate about a torque tube rotational axis 19 relative to the solar tracker support structures 12. For example, a bearing housing assembly 16 can be at the solar tracker support structure 12, and the bearing housing assembly 16 (e.g., a pivot bracket) can rotatably receive the torque tube 14 such that the torque tube 14 is rotatably supported at the solar tracker support structure 12.

The solar tracker system 10 can include a plurality of solar modules, or panels, 18 supported on the torque tube 14. Each of the solar modules 18 can include a plurality of photovoltaic cells that are configured to convert incident sunlight into electrical energy. As the torque tube 14 is rotated about the torque tube rotational axis 19, the solar modules 18 can be rotated with the torque tube 14 to change an angular position of the solar modules 18 relative to the sun throughout a given day. The torque tube rotational axis 19 can extend in a north—south direction such that the solar modules 18 are rotated via the torque tube to change an angular orientation of the solar modules 18 in an east-west direction (e.g., torque tube 14 rotated about rotational axis 19 in a first direction to change an angular orientation of the solar modules in an cast direction; torque tube 14 rotated about rotational axis 19 in a second, opposite direction to change an angular orientation of the solar modules in an west direction).

In some examples, multiple torque tubes 14 can be used and can span any number of solar tracker support structure 12. The span between two adjacent solar tracker support structures 12 can referred to as a bay and may be generally in the range of about 8 meters in length. A plurality of solar tracker rows may be arranged in a north-south longitudinal orientation to form a solar array or power plant.

The solar tracker system 10 can include at least one drive component 20 (e.g., a slew drive component or drive motor) operably coupled to the torque tube 14 and supported at a solar tracker support structure 12. The drive component 20 can drive rotation of the torque tube 14, and thus the solar modules 18 attached to the torque tube 14, such that the solar modules 18 can track the location of the sun. Other methods for rotating the torque tube 14 can also be used.

The following will describe various embodiments of features for a solar tracker support structure. For example, any one or more of these disclosed solar tracker support structure features can be used as part of a broader solar tracker system, such as the example discussed with respect to FIG. 1. Any one or more of the solar tracker support structure features disclosed herein with respect to a particular illustrated embodiment of a solar tracker support structure can be used with any of the other solar tracker support structure embodiments disclosed elsewhere herein.

Embodiments of solar tracker support structures are disclosed as follows which include a first pair of pivot joints and a second pair of pivot joints at a common solar tracker support structure. The first pair of pivot joints can be configured to move the solar tracker support structure 200 about a first axis, while the second pair of pivot joints can be configured to move the solar tracker support structure 200 about a second, different axis. The first pair of pivot joints can move (e.g., pivot, rotate) independently of, about the different axis, the second pair of pivot joints. The first pair of pivot joints can include a first pair first pivot joint at a first leg of the solar tracker support structure 200 and a first pair second pivot joint at a second leg of the solar tracker support structure 200, and the second pair of pivot joints can include a second pair first pivot joint at the first leg and spaced apart from the first pair first pivot joint and a second pair second pivot joint at the second leg and spaced apart from the first pair first pivot joint. Each of the first pair first pivot joint, first pair second pivot joint, second pair first pivot joint, and second pair second pivot joint can be configured to move the solar tracker support structure 200 independent of each of the other pivot joints. For example, the first pair first pivot joint can be configured to move the solar tracker support structure (e.g., first leg) independent of each of the second pair first pivot joint, first pair second pivot joint, and second pair second pivot joint. The same can be true for independent movement at each of the other pivot joints.

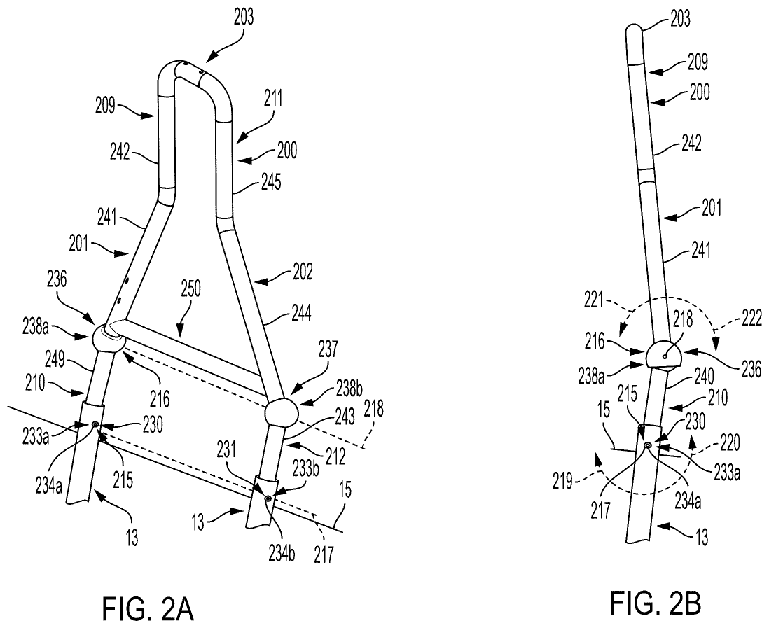

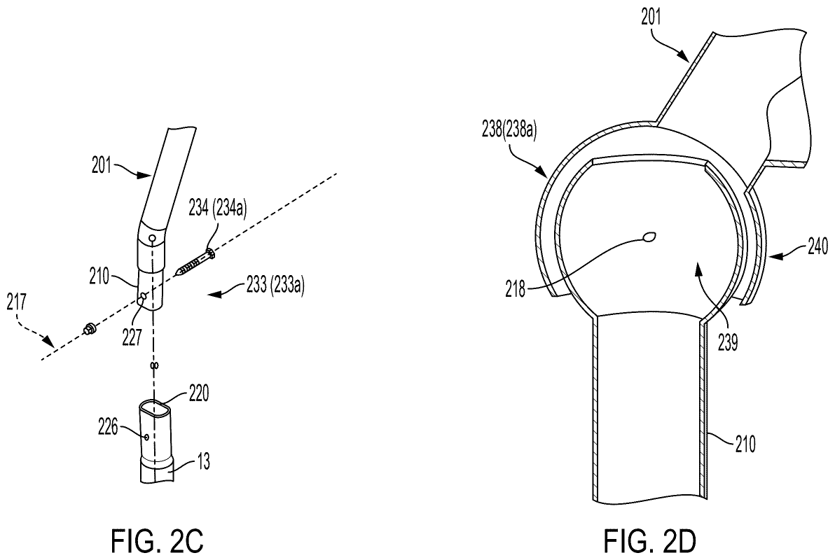

FIGS. 2A-2D illustrate one embodiment of a solar tracker support structure 200. FIG. 2A is a first side view of the solar tracker support structure 200, and FIG. 2B is a second side view of the solar tracker support structure 200 approximately ninety degrees offset from the first side view at FIG. 2A. The embodiment of the solar tracker support structure 200 includes one pair of pivot joints that includes a pin joint as a type of pivot joint and another pair of pivot joints that includes a ball joint as a type of pivot joint. FIG. 2C is an exploded view of an embodiment of the pin joint as a type of pivot joint at the solar tracker support structure 200, and FIG. 2D is an elevational view of an embodiment of a ball joint as a type of pivot joint at the solar tracker support structure 200.

The illustrated solar tracker support structure 200 includes multiple legs 201, 202. For example, the solar tracker support structure 200 can be a two-legged type of A-frame truss configured to support the torque tube 14. Though in other embodiments other types of solar tracker support structures 200 can be used with multiple legs.

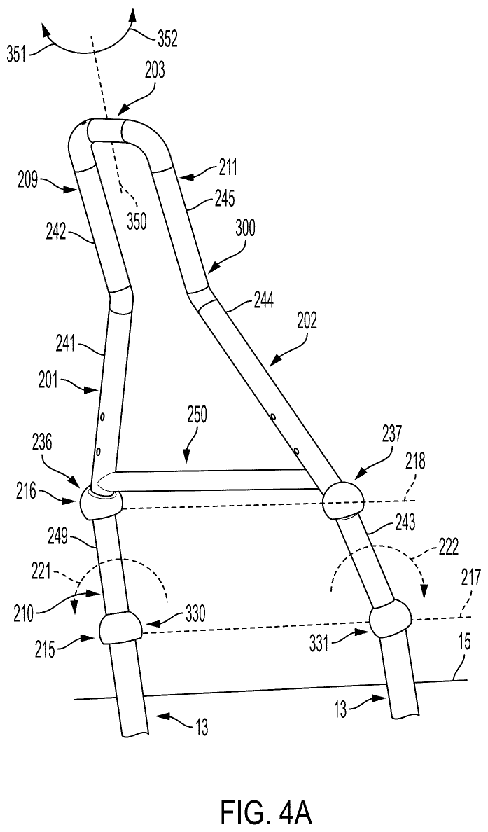

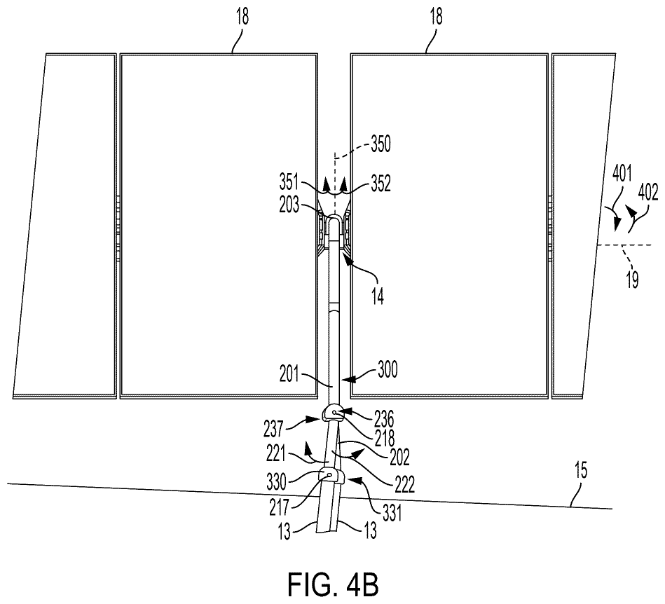

The solar tracker support structure 200 can include a first leg 201, a second leg 202, and a bridge 203. The first leg 201 can include a first leg proximal end portion 209 and a first leg distal end portion 210. The second leg 202 can include a second leg proximal end portion 211 and a second leg distal end portion 212. The bridge 203 can extend between the first leg 201 and the second leg 202. As shown here, the bridge 203 can extend between the first leg proximal end portion 209 and the second leg proximal end portion 211. In this way, the bridge 203 can bridge between the first and second legs 201, 202 and provide an interface thereat for receiving and supporting one or more solar tracker system components. For example, the bridge 203 can be configured to rotatably support the torque tube of a solar tracker system (e.g., as shown at FIG. 4B such that the torque tube 14 is suspended below the bridge 203).

The solar tracker support structure 200 further includes a first pair of pivot joints 215 and a second pair of pivot joints 216. The first pair of pivot joints 215 can be configured to move independent of the second pair of pivot joints 216. For various such examples, the first pair of pivot joints 215 can be configured to move the solar tracker support structure 200 about a first axis 217, while the second pair of pivot joints 216 can be configured to move the solar tracker support structure 200 about a second, different axis 218. The first axis 217 can extend through the first pair of pivot joints 215, and the second axis 218 can extend through the second pair of pivot joints 216. Referring to the example illustrated at FIG. 2B, the first pair of pivot joints 215 can be configured to move the solar tracker support structure 200 about the first axis 217 in directions 219, 220, and the second pair of pivot joints 216 can be configured to move the solar tracker support structure 200 about the second axis 218 in directions 221, 222. For some applications, such as that illustrated, the first axis 217 can be generally parallel to the second axis 218. When the solar tracker support structure 200 is used as part of a solar tracker system to support a torque tube, the first axis 217 can extend in an east-west direction and, thus, the first axis 217 can be an east-west extending axis about which the first pair of pivot joints 215 can be configured to move the solar tracker support structure 200. For such an example with the first axis 217 extending in an east-west direction, the pivot direction 219 about the first east-west axis 217 can be one of north and south and the pivot direction 220 about the first east-west axis 217 can be the other of north and south. Likewise, for such an exemplary application, when the second axis 218 extends generally parallel to the first axis 217, the second axis 218 can also then extend in an east-west direction and, thus, the second axis 218 can be an east-west extending axis about which the second pair of pivot joints 216 can be configured to move the solar tracker support structure 200. Again, for such an example, the pivot direction 221 about the east-west axis 218 can be one of north and south and the pivot direction 222 about the east-west axis 218 can be the other of north and south.

The first pair of pivot joints 215 can include a first pair first pivot joint 230 at the first leg 201 and a first pair second pivot joint 231 at the second leg 202. As noted, this first pair of pivot joints 215 can be configured to move the solar tracker support structure 200 about the first axis 217 and, thus, the first pair first pivot joint 230 can be configured to move the first leg 201 of the support structure 200 about the first axis 217 and the first pair second pivot joint 231 can be configured to move the second leg 202 of the support structure 200 about the first axis 217.

The illustrated embodiment shown at FIGS. 2A-2D includes the first pair first pivot joint 230 and the first pair second pivot joint 231 each as a pin joint 233. FIG. 2C illustrates an exploded view of one embodiment of the pin joint 233 that can be used as the first pair first pivot joint 230 and the first pair second pivot joint 231. Thus, a first pin joint 233a can be included at the first leg 201 as the first pair first pivot joint 230 and a second pin joint 233b can be included at the second leg 202 as the first pair second pivot joint 231. The first pin joint 233a can include a first pin 234a that extends through the first leg 201 and a first subterranean pile 13 along the first axis 217, and the second pin joint 233b can include a second pin 234b that extends through the second leg 202 and a second subterranean pile 13 along the first axis 217.

As noted, the first leg 201 can include the first leg distal end portion 210, and the second leg 202 can include the second leg distal end portion 212. The first leg distal end portion 210 can be configured to couple to the first subterranean pile 13, and the second leg distal end portion 212 can be configured to couple to a second subterranean pile 13. The illustrated embodiment shows that the first pin joint 233a can couple the first leg distal end portion 210 to the first subterranean pile 13 and the second pin joint 233b can couple the second leg distal end portion 212 to the second subterranean pile 13. In particular, a proximal end portion 220 of each of the first and second subterranean piles 13 can include a pin aperture 226, and the pin aperture 226 at the proximal end portion 220 of each of the first and second subterranean piles 13 can be configured to receive the respective pin 234a, 234b. Each of the distal end portion 210 of the first leg 201 and the distal end portion 212 of the second leg 202 can include a leg pin aperture 227 that is configured to receive the respective pin 234a, 234b extending through the respective pin aperture 226 at the respective first or second subterranean pile 13. As such, the first pair first pivot joint 230 can be closer to the first leg distal end portion 210 than a portion of the second pair of pivot joints 216 (e.g., second pair first pivot joint) also at the first leg 201, and the first pair second pivot joint 231 can be closer to the second leg distal end portion 212 than a portion of the second pair of pivot joints 216 (e.g., second pair second pivot joint) also at the second leg 202. Thus, for some embodiments such as that illustrated here, the first pair first pivot joint 230 can be aligned with the first pair second pivot joint 231 about the axis 217 that extends horizontally to ground 15 at a first elevation along the solar tracker support structure 200, and the portion of the second pair of pivot joints 216 at the first leg 201 can be aligned with the portion of the second pair of pivot joints 216 at the second leg 202 about the axis 218 that extends horizontally to ground 15 at a second elevation along the solar tracker support structure 200 with this second elevation, of the axis 218, being higher above ground than the first elevation, of the axis 217.

The second pair of pivot joints 216 can include a second pair first pivot joint 236 at the first leg 201 and a second pair second pivot joint 237 at the second leg 202. As noted, this second pair of pivot joints 216 can be configured to move the solar tracker support structure 200 about the second axis 218 and, thus, the second pair first pivot joint 236 can be configured to move the first leg 201 of the support structure 200 about the second axis 218 and the second pair second pivot joint 237 can be configured to move the second leg 202 of the support structure 200 about the second axis 218. The second pair first pivot joint 236 can be spaced apart from the first pair first pivot joint 230 along the first leg 201, the second pair second pivot joint 237 can be spaced apart from the first pair second pivot joint 231 along the second leg 202. For the illustrated embodiment, the second pair first pivot joint 236 can be spaced apart from the first pair first pivot joint 230 along the first leg 201 such that the second pair first pivot joint 236 is at a greater elevation above ground 15 than the first pair first pivot joint 230, the second pair second pivot joint 237 can be spaced from the first pair second pivot joint 231 along the second leg 202 such that the second pair second pivot joint 237 is at a greater elevation above ground 15 than the first pair second pivot joint 231. Further details with respect to a pin joint can be found in U.S. patent application No. 63/623,740 filed on Jan. 22, 2024, the contents of which are hereby incorporated by reference.

The illustrated embodiment shown at FIGS. 2A-2D includes the second pair first pivot joint 236, at the first leg 201, and the second pair second pivot joint 237, at the second leg 202, each as including a ball joint 238. FIG. 2D illustrates a first ball joint 238A included as the second pair first pivot joint 236 at the first leg 201 and a second ball joint 238b included as the second pair second pivot joint 237 at the second leg 202.

Each ball joint 238, such as shown at the example embodiment at FIG. 2D, can include a ball member 239 and a socket member 240. The socket member 240 can be configured to move about the ball member 239 to cause the respective first and second legs 201, 202 to each move about the axis 218. The movement of the first leg 201 about the ball member 239 of the second pair first pivot joint 236 at the axis 218 can be independent of the movement of the second leg 202 about the ball member 239 of the second pair second pivot joint 237 at the axis 218. As applied to the ball joint 238 at each of the second pair first pivot joint 236 and the second pair second pivot joint 237, the ball member 239 can be included at respective first and second leg distal portion 210, 212, while the socket member 240 can be included at the respective first and second leg proximal to the respective first and second leg distal portion 210, 212. As one example, the ball joint 238 of each of the second pair first pivot joint 236 at the first leg 201 and the second pair second pivot joint 237 at the second leg 202 can each include a hydroformed ball joint. For such an example, each of the ball member 239 and the socket member 240 can be hydroformed portions of a single piece, integral hydroformed ball joint.

The inclusion of each of the first pair of pivot joints 215 and the second pair of pivot joints 216 at the legs 201, 202 of the support structure 200 can be useful in imparting movement ability to the support structure 200 about different axes, which, for instance, can be useful in accommodating movement of solar tracker system components supported at such support structure 200. For example, as a component (e.g., torque tube and/or bearing housing assembly) of a solar tracker system supported at the support structure 200 is moved, the support structure 200 can be moved about the different axes of the first pair of pivot joints 215 and the second pair of pivot joints 216 in a way that can avoid posing significant interference on the moving, support structure-supported solar tracker system component and/or can maintain a general relative orientation between the support structure 200 and the support structure-supported solar tracker system component.

For some embodiments, the support structure 200 can include one or more complementary structural features that can be useful when the first pair of pivot joints 215 and the second pair of pivot joints 216 are included at the legs 201, 202 of the support structure 200. Such structural features at the support structure complementary to the inclusion of the first pair of pivot joints 215 and the second pair of pivot joints 216, and thus complementary to the configuration of the legs 201, 202 of the support structure 200 to move about the different axes 217 218, will be described as follows.

As seen best at the example of FIG. 2A, the first leg 201 can include a first leg distal vertical segment 249 at the first leg distal end portion 210, a first leg convergence segment 241 between the first leg distal end portion 210 and the first leg proximal end portion 209, and a first leg proximal vertical segment 242 at the first leg proximal portion 209. Similarly, the second leg 202 can include a second leg distal vertical segment 243 at the second leg distal end portion 212, a second leg convergence segment 244 between the second leg distal end portion 212 and the second leg proximal end portion 211, and a second leg proximal vertical segment 245 at the second leg proximal portion 211. The leg convergence segments 241, 244 can act to increase the height of the support structure 200 above ground 15 while also narrowing a width of the support structure 200 as the height of the support structure 200 extends about ground 15.

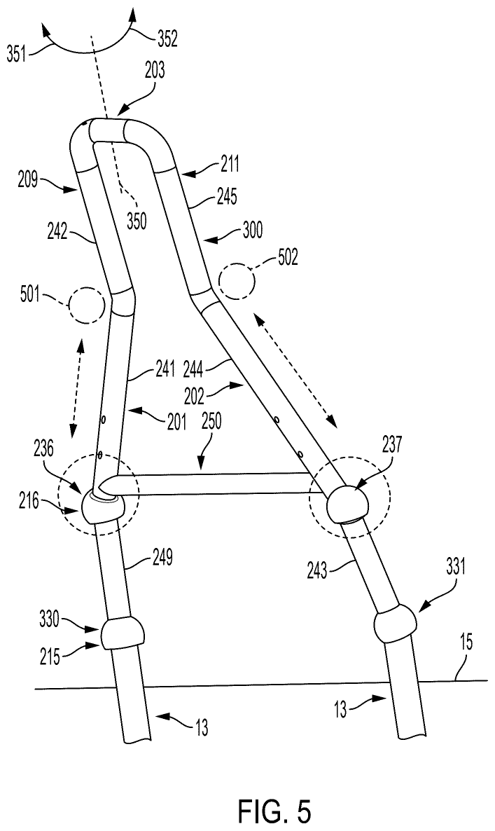

As shown for the illustrated embodiment, each of the first pair first pivot joint 230 and the second pair first pivot joint 236 can be at the first leg distal vertical segment 249 and each of the first pair second pivot joint 231 and the second pair second pivot joint 237 can be at the second leg distal vertical segment 243. Though, as shown at the example of FIG. 5, for some embodiments the location of the pivot joints 216, 216 can be at other portions of the first and second legs 201, 202. The bridge 203 can extend between the first leg proximal vertical segment 242 at the first leg proximal portion 209 and the second leg proximal vertical segment 245 at the second leg proximal portion 211 to bridge together the first and second leg proximal vertical segments 242, 245. As noted previously, the bridge 203 can be configured to couple to a torque tube of a solar tracker system, for instance, via a bearing housing assembly at the bridge 203.

As further shown at the embodiment of FIG. 2A, the support structure 200 can further include one or more cross-braces 250. The cross-brace 250 as shown at FIG. 2A can extend between the first leg 201 and the second leg 202. More specifically, the illustrated example shows the cross-brace 250 is at the first leg convergence segment 241 and closer to the first leg proximal end portion 209 than each of the first pair first pivot joint 230 and the second pair first pivot joint 236 at the first leg 201. Similarly, the illustrated example shows the cross-brace 250 is at the second leg convergence segment 244 and closer to the second leg proximal end portion 211 than each of the first pair second pivot joint 231 and the second pair second pivot joint 237 at the second leg 202.

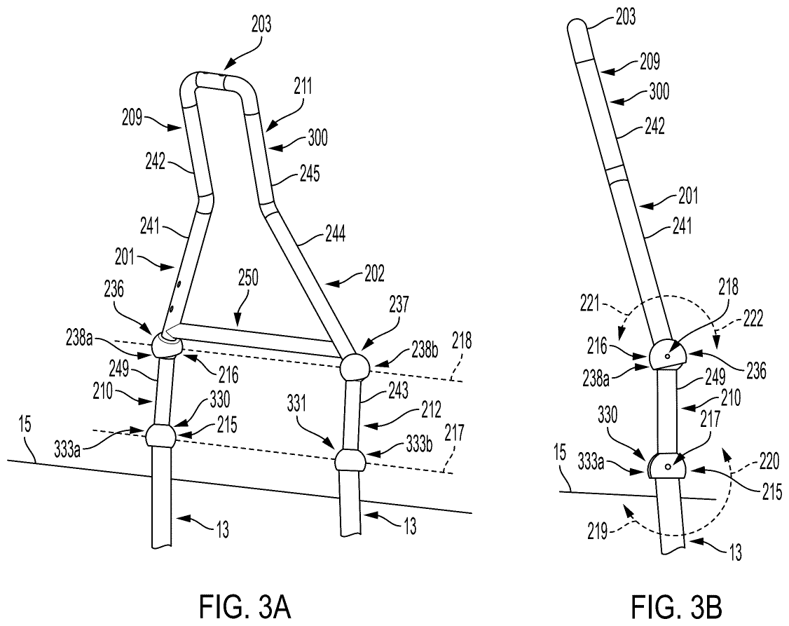

FIGS. 3A-3B illustrate another embodiment of a solar tracker support structure 300. FIG. 3A is a first side view of the solar tracker support structure 300, and FIG. 3B is a second side view of the solar tracker support structure 300 approximately ninety degrees offset from the first side view at FIG. 3A. For various embodiments, the solar tracker support structure 300 can be similar to, or the same as, the solar tracker support structure 200 described and illustrated elsewhere herein except as described as follows. More specifically, the solar tracker support structure 300 can be the same as that described and illustrated elsewhere herein for the solar tracker support structure 200 except that the solar tracker support structure 300 can replace the pin joints 233a, 233b included at the first pair of pivot joints 215 for structure 200 instead with ball joints at the first pair of pivot joints 215 for structure 300, as will be descried as follows. For example, the solar tracker support structure 300 can include one or more (e.g., each) of the features described and/or illustrated with respect to the support structure 200 except that the support structure 300 can use a ball joint for the first pair of pivot joints 215.

Referring to the support structure 300 embodiment shown at FIGS. 3A and 3B, the support structure 300 can include the first pair of pivot joints 215 as ball joints. Namely, the first pair of pivot joints 215 can include first pair first pivot joint 330 as a first ball joint 333a and first pair second pivot joint 331 as a second ball joint 333b. The first pair first ball joint 333a can be at the first leg 201 and the first pair second ball joint 333b can be at the second leg 202. As also shown for the support structure 300, the second pair of pivot joints 216 can include ball joints first and second ball joints 238a, 238b as described previously. Thus, the support structure 300 can include four ball joints 333a, 333b, 238a, 238b at the first and second pairs of pivot joints 215, 216. The ball joints 333a, 333b can be configured to move the support structure 300 about the axis 217 in directions 219, 220, and the ball joints 238a, 238b can be configured to move the support structure 300 about the different axis 218 in directions 221, 222. The support structure 300 can be configured to pivot about the ball joint 333a and axis 217 in directions 219, 220 independent of the movement of the support structure 300 about the ball joint 333b in directions 219, 220. Likewise, the support structure 300 can be configured to pivot about the ball joint 238a and axis 218 in directions 221, 222 independent of the movement of the support structure 300 about the ball joint 238b in directions 221, 222.

FIGS. 4A-4B illustrate solar tracker support structure 300 having first pair of pivot joints 215 configured to move the solar tracker support structure 300 about first axis 217 and second pair of pivot joints 216 configured to move the solar tracker support structure 300 about second, different axis 218. FIG. 4A is a side view showing movement of the support structure 300 about the first axis 217 via the first pair of pivot joints 215 and about the second axis 218 via the second pair of pivot joints 216, and FIG. 4B is a side view showing how such movement of the support structure 300 about the first and second axes 217, 218 can accommodate increased angular solar module 18 stow position. The example at FIGS. 4A and 4B shows the support structure 300, though it is to be understood that the support structure 200 could be similarly shown at FIGS. 4A and 4B as the support structure 300 is shown to execute the imparted yaw at the support structure 200 as described as follows.

Referring to the example shown at FIG. 4A, the first pair of pivot joints 215 can be configured to move the support structure 300 about axis 217. FIG. 4A shows the first pair first pivot joint 330 moving the first leg 201 of support structure 300 about axis 217 in direction 221 (e.g., one of north and south direction) and the first pair second pivot joint 331 moving the second leg 202 of support structure 300 about axis 217 in direction 222 which can be an opposite direction to direction 221 (e.g., direction 222 can be the other of north and south direction). Movement of the first pair of pivot joints 215 can act to cause further movement of the support structure 300 about the axis 218, and, thus, about the second pair of pivot joints 216. For example, when the first pair first pivot joint 330 moves the first leg 201 of support structure 300 about axis 217 and when the first pair second pivot joint 331 moves the second leg 202 of support structure 330 about the axis 217, the support structure can also be caused to move about the second pair of pivot joints 216 at the axis 218. As one such specific example, when the first pair first pivot joint 330 moves the first leg 201 of support structure 300 about axis 217 in direction 221 and the first pair second pivot joint 331 moves the second leg 202 of support structure 300 about axis 217 in direction 222, the second pair of pivot joints 216 can be configured to impart yaw at the solar tracker support structure 300 to cause the solar tracker support structure 300 to twist, in direction 351 or 352, about a vertical yaw axis 350 to ground. For instance, where the axes 217, 218 extend in an cast-west orientation, as the first pair first pivot joint 330 and the first pair second pivot joint 331 are rotated about their east-west axis 217, the second pair first pivot joint 236 and the second pair second pivot joint 237 can be caused to rotate about the vertical yaw axis 350 to ground 15 to cause the solar tracker support structure 300 to twist about the vertical yaw axis 350 to ground 15.

The configuration of the first pair of pivot joints 215 and the second pair of pivot joints 216 to cause the support structure to twist about the yaw axis 350 can be useful for a variety of purposes, depending on the specific end-use application. The described configuration of the first pair of pivot joints 215 to move independently from one another about the axis 217 to then cause the second pair of pivot joints 216 to move independently from one another about the axis 218 to then cause the support structure 300 to twist about the vertical yaw axis 350 can be useful in maintaining a relative orientation between the torque tube 14 and the support structure 300 and/or to avoid interference on the solar modules 18 by the support structure 300 so as to help increase a maximum rotational stow position of the solar modules 18. As one such example referring to FIG. 4B, the second pair of pivot joints 216 can be configured to impart yaw at the solar tracker support structure 300 to cause the solar tracker support structure 300 to twist about the vertical yaw axis 350 where such twisting of the support structure 300 about the yaw axis 350 can act to move the support structure out of at least a portion of a rotational path of one or more solar modules 18 to thereby avoid interference of the support structure 300 in the rotational path of the one or more solar modules 18 which can thus act to increase a rotational range of motion of the one or more solar modules 18 as the torque tube 14 is rotated about its rotational axis 19.

For instance, in one such application, the second pair of pivot joints 216 can be configured to impart yaw, about the yaw axis 350, at the solar tracker support structure 300 to cause the solar tracker support structure 300 to twist about the yaw axis 350 to accommodate a solar module stow position up to positive seventy five degrees in one rotational direction 401 and up to minus seventy five degrees in another, opposite rotational direction 402. In prior solar tracker support structure applications, without the ability to impart yaw, about yaw axis 350, at the support structure 350 to cause the support structure 350 to twist about the yaw axis 350, the solar modules 18 at each side of the support structure would come into contact with the interfering support structure such that the maximum solar module stow position would be notably less than ±75 degrees (e.g., ±60 degrees). Thus, the ability of the support structure 300 to twist about the yaw axis 350 can allow the solar modules 18 to be rotated to a greater angular extent in directions 401, 402 by torque tube 14, which in turn can increase the functionality and performance of the solar tracker system (e.g., allowing for a greater angular degree stow position which, for instance, can help to reduce loading, such as wind loading, on the solar tracker system).

FIG. 5 is a schematic diagram showing various locations along the solar module support structure 300 for a pair of pivot joints 215, 216. As illustrated previously, the first pair of pivot joints 215 and the second pair of pivot joints 216 can be included at the first leg distal vertical segment 249 and the second leg distal vertical segment 243. However, for other embodiments the first pair of pivot joints 215 and the second pair of pivot joints 216 can be included at different locations at the first and second legs 201, 202. As one example, the second pair of pivot joints 216 can be included at the first and second leg convergence segments 241, 244, while the first pair of pivot joints 215 are included at the first and second leg distal vertical segments 249, 243. As another example, the second pair of pivot joints 216 can be included at intersection 501 of the first leg convergence segment 241 and the first leg proximal vertical segment 242 and at intersection 502 of the second leg convergence segment 244 and the second leg proximal vertical segment 245, while the first pair of pivot joints 215 are included at the first and second leg distal vertical segments 249, 243. As yet another example, the second pair of pivot joints 216 can be included at the first and second leg proximal vertical segments 242, 245, while the first pair of pivot joints 215 are included at the first and second leg distal vertical segments 249, 243. In other examples within the scope of this disclosure, the first pair of pivot joints 215 can be located elsewhere at the respective first and second legs 201, 202 other than the first and second leg distal vertical segments 249, 243.

Various examples have been described. These and other examples are within the scope of the following claims.

What is claimed is:

1. A solar tracker support structure comprising:
a first leg, the first leg comprising a first leg proximal end portion and a first leg distal end portion;
a second leg, the second leg comprising a second leg proximal end portion and a second leg distal end portion;
a bridge extending between the first leg proximal end portion and the second leg proximal end portion;
a first pair of pivot joints comprising a first pair first pivot joint at the first leg and a first pair second pivot joint at the second leg, the first pair of pivot joints configured to move the solar tracker support structure about a first axis; and
a second pair of pivot joints comprising a second pair first pivot joint at the first leg and a second pair second pivot joint at the second leg, the second pair first pivot joint spaced apart from the first pair first pivot joint along the first leg, the second pair second pivot joint spaced apart from the first pair second pivot joint along the second leg, the second pair of pivot joints configured to move the solar tracker support structure about a second axis.

2. The solar tracker support structure of claim 1, wherein the first axis is an east-west axis, and wherein the second axis is a vertical yaw axis to ground.

3. The solar tracker support structure of claim 2, wherein the second pair of pivot joints are configured to impart yaw at the solar tracker support structure to cause the solar tracker support structure to twist about the vertical yaw axis to ground.

4. The solar tracker support structure of claim 3, wherein as the first pair first pivot joint and the first pair second pivot joint pivot in a north or south direction, the second pair first pivot joint and the second pair second pivot joint are caused to rotate about the vertical axis to ground to twist the solar tracker support structure about the vertical yaw axis to ground.

5. The solar tracker support structure of claim 3, wherein the first leg distal end portion is configured to couple to a first subterranean pile and the second leg distal end portion is configured to couple to a second subterranean pile, wherein the first pair first pivot joint is closer to the first leg distal end portion than the second pair first pivot joint, and wherein the first pair second pivot joint is closer to the second leg distal end portion than the second pair second pivot joint.

6. The solar tracker support structure of claim 3, wherein the first pair first pivot joint is aligned with the first pair second pivot joint about a first pair axis that extends horizontally to ground at a first elevation along the solar tracker support structure, and wherein the second pair first pivot joint is aligned with the second pair second pivot joint about a second pair axis that extends horizontally to ground at a second elevation along the solar tracker support structure, the second elevation being higher above ground than the first elevation.

7. The solar tracker support structure of claim 3, wherein the first pair first pivot joint at the first leg and the first pair second pivot joint at the second leg each comprise a pin joint, and wherein the second pair first pivot joint at the first leg and the second pair second pivot joint at the second leg each comprise a ball joint.

8. The solar tracker support structure of claim 7, wherein the pin joint at the first pair first pivot joint comprises a first pin that extends through the first leg and a first subterranean pile along the first axis, and wherein the pin joint at the first pair second pivot joint comprises a second pin that extends through the second leg and a second subterranean pile along the first axis.

9. The solar tracker support structure of claim 3, wherein the first pair first pivot joint at the first leg and the first pair second pivot joint at the second leg each comprise a ball joint, and wherein the second pair first pivot joint at the first leg and the second pair second pivot joint at the second leg each comprise a ball joint.

10. The solar tracker support structure of claim 9, wherein the ball joint of each of the first pair first pivot joint at the first leg and the first pair second pivot joint at the second leg each comprises a hydroformed ball joint, and wherein the ball joint of each of the second pair first pivot joint at the first leg and the second pair second pivot joint at the second leg each comprises a hydroformed ball joint.

11. The solar tracker support structure of claim 3, wherein the second pair of pivot joints are configured to impart yaw at the solar tracker support structure to cause the solar tracker support structure to twist about the vertical yaw axis to ground to accommodate a solar module stow position up to positive seventy five degrees in one rotational direction and up to minus seventy five degrees in another, opposite rotational direction.

12. The solar tracker support structure of claim 1,
wherein the first leg comprises a first leg distal vertical segment at the first leg distal end portion, a first leg convergence segment between the first leg distal end portion and the first leg proximal end portion, and a first leg proximal vertical segment at the first leg proximal portion, and
wherein the second leg comprises a second leg distal vertical segment at the second leg distal end portion, a second leg convergence segment between the second leg distal end portion and the second leg proximal end portion, and a second leg proximal vertical segment at the second leg proximal portion.

13. The solar tracker support of claim 12, wherein each of the first pair first pivot joint and the second pair first pivot joint is at the first leg distal vertical segment, wherein each of the first pair second pivot joint and the second pair second pivot joint is at the second leg distal vertical segment.

14. The solar tracker support of claim 13, wherein the bridge is configured to couple to a torque tube of a solar tracker system.

15. The solar tracker support of claim 14, wherein the solar tracker support structure further comprises:
a cross-brace extending between the first leg and the second leg.

16. The solar tracker support of claim 15, wherein the cross-brace is at the first leg convergence segment and closer to the first leg proximal end portion than each of the first pair first pivot joint and the second pair first pivot joint at the first leg, and wherein the cross-brace is at the second leg convergence segment and closer to the second leg proximal end portion than each of the first pair second pivot joint and the second pair second pivot joint at the second leg.

17. A solar tracker support structure comprising:
a first leg, the first leg comprising a first leg proximal end portion and a first leg distal end portion;
a second leg, the second leg comprising a second leg proximal end portion and a second leg distal end portion;
a bridge extending between the first leg proximal end portion and the second leg proximal end portion;
a first pair of pivot joints comprising a first pair first pivot joint at the first leg and a first pair second pivot joint at the second leg, the first pair of pivot joints configured to move the solar tracker support structure about a first axis; and
a second pair of pivot joints comprising a second pair first pivot joint at the first leg and a second pair second pivot joint at the second leg, the second pair first pivot joint spaced apart from the first pair first pivot joint along the first leg, the second pair second pivot joint spaced apart from the first pair second pivot joint along the second leg, the second pair of pivot joints configured to move the solar tracker support structure about a second axis,
wherein the second pair of pivot joints are configured to impart yaw at the solar tracker support structure to cause the solar tracker support structure to twist about the second axis.

18. The solar tracker support structure of claim 17, wherein the first axis is an east-west axis, and wherein the second axis is a vertical axis to ground.

19. The solar tracker support structure of claim 18, wherein as the first pair first pivot joint and the first pair second pivot joint pivot in a north or south direction, the second pair first pivot joint and the second pair second pivot joint are caused to rotate about the vertical axis to ground to twist the solar tracker support structure about the vertical axis to ground.

20. The solar tracker support structure of claim 19, wherein the first pair first pivot joint is aligned with the first pair second pivot joint about a first pair axis that extends horizontally to ground at a first elevation along the solar tracker support structure, and wherein the second pair first pivot joint is aligned with the second pair second pivot joint about a second pair axis that extends horizontally to ground at a second elevation along the solar tracker support structure, the second elevation being higher above ground than the first elevation.
